(19) United States
(12) Patent Application Publication
(10) Pub. No.: US 2022/0170653 A1
(43) Pub. Date: Jun. 2, 2022

(54) BUSINESS FACILITY WITH AN EXTERIOR MICROBIOME

(71) Applicant: Phylagen, Inc., San Francisco, CA (US)

(72) Inventors: Jessica L. Green, Berkeley, CA (US); Harrison F. Dillon, San Francisco, CA (US)

(73) Assignee: Phylagen, Inc., San Francisco, CA (US)

(21) Appl. No.: 17/180,627

(22) Filed: Feb. 19, 2021

Related U.S. Application Data
(63) Continuation of application No. 15/071,148, filed on Mar. 15, 2016, now abandoned.
Application No. 15/071,148 is a continuation of application No. 14/960,227, filed on Dec. 4, 2015, now abandoned.
(60) Provisional application No. 62/088,515, filed on Dec. 5, 2014.

(51) Int. Cl. F24F 11/30; G05B 15/02

(52) U.S. Cl. CPC F24F 11/30; F24F 2110/50; G05B 15/02

(57) ABSTRACT

The microbiome of interior space within a business facility often differs markedly from its exterior. The difference may result from attempts to reduce microbes from the outside from entering the structure housing the business, attempts to kill microbes within the structure, or the provision of an environment that promotes growth of different microbes within the structure due to differences in temperature, humidity and nutrients available. The operation of a business or its facility can be changed to influence the composition of the interior microbiome and make it more similar to an exterior microbiome without an intolerable loss of the desired proactive features of the structure housing the business. The improved microbiome can result in health benefits of workers of the business and other business efficiencies, such as reduced spoilage of product.

### CROSS-REFERENCE TO RELATED APPLICATION

The present application is a continuation of U.S. non-provisional application Ser. No. 15/071,148, filed Mar. 15, 2016, which is a continuation of U.S. non-provisional application Ser. No. 14/960,227, filed Dec. 4, 2015, which is a non-provisional of U.S. provisional application No. 62/088,515, filed Dec. 5, 2014, each of which is hereby incorporated by reference in its entirety for all purposes.

### BACKGROUND

Microbes can have both harmful and beneficial effects on human health. Microbes can be a source of infections, can release toxic chemicals, or can cause asthma and allergies. Conversely, microbes can induce resistance to infections and tolerance of allergies and asthma and release biologics that mitigate the effect of toxic chemicals. As well as microbes, the outdoor environment may contain particulates and chemicals, which can be harmful to health in causing cancers and inflammation among other disorders. The concentration of such particulates and chemicals depends on location and time of day.

A structure separates indoor and outdoor spaces. But interior and exterior spaces can to some extent exchange indoor and outdoor environments via HVAC systems, plumbing and passage of people into and out of the structure and the like. Businesses may take steps to remove microbes such as by filtering air and cleaning surfaces with anti-microbial agents. Still large amounts of microbes inevitably remain given the continual passage of people, air, water and other materials into the interior of a facility. These microbes present risks to the efficient operation of a business.

### SUMMARY OF THE CLAIMED INVENTION

The invention provides methods of improving a business environment. Such methods include determining a microbiome of an interior space of a business facility; changing the operation of the facility or the business; redetermining the microbiome of the interior space; and comparing the interior microbiome before and after the change to an exterior microbiome, wherein if the interior microbiome after the change more closely resembles the exterior microbiome, the change is retained in subsequent operation of the business.

In some methods, the exterior microbiome is a reference exterior microbiome. In some methods, the exterior microbiome is an exterior microbiome of the business facility determined before or after the change.

In some methods, the change introduces interior plants. In some methods, steps (b)-(d) are repeated with a different change of operation being performed in step (b). In some methods, the change introduces exterior plants. In some methods, the exterior plant is a lawn or tree. In some methods, the change increases diversity of microbes within the exterior microbiome. In some methods, the change introduces at least 10 new species within 100 meters of the structure(s) of the facility. In some methods, the change introduces companion animals into the interior of the facility. In some methods, the change comprises increasing the ratio of natural materials to synthetic materials on surfaces. In some methods, the change comprises introducing a concentrated source of microbes to the interior of the structure. In some methods, the change changes operation of the HVAC system to increase airflow from the exterior. In some methods, the change results in 10%-100% of air delivered by the HVAC being exterior air.

Some methods also include monitoring exterior air and increasing airflow from the exterior responsive to the monitoring. In some methods, the airflow is increased when particulates in the exterior air are below a threshold. In some methods, the temperature inside the structure is allowed to vary within a set range without reducing the amount of exterior air, such as a range of 14-28° C. In some methods, the relative humidity inside the structure is allowed to vary within a set range without reducing the amount of exterior air, such as 15-85% relative humidity. In some methods, the airflow is increased when a chemical in exterior air falls below a threshold. In some methods, the airflow is increased when exterior temperature is within a range compatible with the HVAC system.

In some methods, the change changes the relative humidity of the interior. In some methods, the change changes the flooring, ceiling tiles, paint, furniture composition, fabric, carpet, door handles and knobs, computers, light switches, personal electronic devices, bed linens, baseboards, wainscoting, materials inside wall cavities, hand drying devices and materials. In some methods, the change changes the plumbing, such as the drain design, incoming water treatment design or operation. In some methods, the change changes the turnover, flow or density of human occupants per square foot of the interior. In some methods, the change comprises the opening and operation of windows, square footage of windows, number of panes, and/or type of transparent material.

In some methods, the interior microbiome is less diverse than the exterior microbiome. In some methods, the change increases the diversity of the airborne, fomite or dust interior microbiome, or any combination of the three. In some methods, the change increases the diversity of fungi, bacteria, viruses in the interior microbiome, or any combination of the three. In some methods, the change increase the content of Proteobacteria or Acinetobacter in the interior microbiome. In some methods, the change reduces the interior microbiome content of mycobacteria, Aspergillus, Clostridium difficile, Staphylococcus, influenza, Pneumococcus. In some methods, the change reduces the interior microbiome content of antibiotic-resistant bacteria and/or antibiotic resistance genes, virulence factors. In some methods, the change comprises a change in cleaning agents or regime used in the interior. In some methods, the change comprises a change in interior surfaces. In some methods, the change comprises a change in temperature and/or relative humidity.

In some methods, workers of the business have fewer sick days in the subsequent operation of the business. In some methods, spoilage of products is reduced in the subsequent operation of the business. In some methods, the frequency of asthma and allergies is reduced in workers in the subsequent operation of the business. In some methods, the frequency of hospital acquired infections is reduced in the subsequent operation of the business. In some methods, the amount of ozone, VOCs, MVOCs, particulates, NO2 and any combination of the foregoing are reduced in the subsequent operation of the business.

Some methods includes collecting samples at representative locations and analyzing the samples for a nucleic acid. Optionally, the nucleic acid is a rRNA. In some methods, the change modifies the air change rate, particle removal efficiency of HVAC filters, or overall filtration rate of interior air or air brought in from the exterior. In some methods, the interior and exterior microbiomes are compared with a data correlating microbiomes with business or facility operations.

In some methods, the change modifies the type (natural and artificial), spectrum, level, and/or consistency of light.

The invention further provides methods of improving a business environment comprising determining a microbiome of an interior space of a business facility; changing the operation of the facility or the business; redetermining the microbiome of the interior space; and comparing the interior microbiome before and after the change wherein if the interior microbiome increases in diversity, the change is retained in subsequent operation of the business.

The invention further provides methods of improving a business environment, comprising determining a microbiome of an interior space of a business facility; changing the operation of the facility or the business; redetermining the microbiome of the interior space; and comparing the interior microbiome before and after the change wherein if the interior microbiome has a decreased content of microbes or gene sequences associated with pathogenicity, allergy, VOC production, toxicity or drug resistance, the change is retained in subsequent operation of the business.

The invention further provides methods of improving a business environment, comprising determining a microbiome of an interior space of a business facility; changing the operation of the facility or the business; redetermining the microbiome of the interior space; and comparing the interior microbiome before and after the change wherein if the interior microbiome has an increased content of Proteobacteria or Acinetobacter, the change is retained in subsequent operation of the business.

The invention further provides methods of improving a business environment, comprising determining a microbiome of the interior of a business facility; collecting information regarding the facility and the business; processing the microbiome and information regarding the facility and the business; and recommending a change in the facility or the business that changes the microbiome the interior to more closely resemble that of exterior space of the facility.

### DEFINITIONS

A business facility refers to a non-naturally occurring structure or group of such structures in which a business is operated typically by one or more human workers occupying the structure(s). The structure or structures contain interior space(s). A business facility also has exterior space surrounding the structure(s). The exterior space can be part of the business as for example when the structure(s) occupy a campus owned or leased by the business. The exterior space can also be owned by an unrelated entity or can be public land, water or air. The exterior space can also be a combination of exterior space that is part of the business, exterior space that is owned by another entity and/or public, land water and air. The exterior space can be a two dimensional surface space or a three dimensional volume space. The exterior space can be defined by distances from a structure (e.g., within 10, 25, 50 or 100 m from the outer walls of the structure) or by natural landmarks (e.g., boundaries of an office park, a river, highway and so forth). A three dimensional space can additionally be defined by height, such as within 10, 25, 50 or 100 m of ground level or with reference to the maximum height of the structure (e.g., 25, 50, 100 or 200% of the maximum height). Business facilities include buildings and commercial vehicles. Buildings include factories (whether enclosed or not), offices, research facilities, residential structures and medical facilities. Vehicles include airplanes, buses, cars, ships, trucks, and vans. A facility can also be a municipality, such as a city or urban area containing a collection of man-made structures that host a microbiome in different areas such as sewers, water supplies, and air in public areas.

A microbiome refers to the microorganisms present in or on a designated object, which may be an animal, a facility or interior or exterior space thereof, a human, or a plant. Microbiome refers to the collective set of microbes (including prokaryotic and eukaryotic microorganisms, and viruses) present in these locations, in terms of both identity and relative abundance. Interior and exterior microbiomes are the microbiomes characterizing the interior and exterior spaces defined above. The type and number of microbes may be inferred from analysis of the nucleic acids present in a given space, as determined by taking samples of material from one or more locations in the space. A microbiome can be provided as single list of microbes occupying space at above background levels, optionally with their absolute or relative representations, or as a matrix whether the different data sets in the matrix correspond to different zones within a space. Thus, for example, different zones can correspond to different rooms or room types (e.g. bathrooms, common areas, offices) within a structure with a list of microbes and optionally their absolute or relative representations being provided for each room.

A facility operation parameter is an environmental condition in a facility. Such conditions include air flow, exposed surface composition (carpet, ceiling tiles, paint, upholstery, and fabric of staff clothing), lighting (natural and artificial), temperature, relative humidity, frequency of cleaning, chemicals used for cleaning, surface moisture pH, CO₂ level, O₂ level, CO level, NO₂ level, VOC level, ozone level, formaldehyde, waste container location and frequency of removal, amount of airborne particulates, particulates of a certain size (PM 2.5, PM 1.0, ultrafine >100 nM) and particle size distribution, lighting, facility volume, heating and cooling systems, and occupant density.

A facility performance indicator refers to a measurable outcome resulting from the operation of the facility. Examples include the frequency, severity and type of infections of patients in a health care facility, yield of raw agricultural material into processed foods or food ingredients, bioburden of processed foods or food ingredients produced by the facility, percent of human occupants sickened, and shelf life of unprocessed produce, processed foods or food ingredients produced by the facility, sterility of pharmaceuticals and medical devices produced by the facility, employee sick days, and operational continuity of the facility or equipment within the facility.

Bioburden is the number of colony forming units of microbes living on a surface or in a substrate. The term is most often used in the context of bioburden testing, also known as microbial limit testing, which is performed on pharmaceutical products, medical device products and food products for quality control purposes. Bioburden can also refer to the total amount of living microbial cells per unit area of a surface or unit volume of liquid or air.

Relative humidity (abbreviated RH) is the ratio of the partial pressure of water vapor to the equilibrium vapor pressure of water at the same temperature. Relative humidity depends on temperature and the pressure of the system of interest.

### DETAILED DESCRIPTION

### I. General

The invention is premised in part on the insight that the microbiome of interior space within a business facility often differs markedly from its exterior. The difference can be manifested as a decreased diversity of microbes in the interior, an increased representation of species known to be pathogenic or a decreased representation of species known to be protective or any combination of these features. The difference may result in part from attempts to reduce microbes from the outside from entering the building (e.g., as a result of air filtration or lack of operable windows), attempts to kill microbes within the structure (e.g., cleaning regimes, sterilizing radiation, “antimicrobial” surfaces), or the provision of an environment that promotes growth of different microbes within a structure due to differences in factors such as temperature, relative humidity, compositions and porosity of surfaces and nutrients available. That a structure provides some barriers to free exchange of external and interior environments is inevitable and necessary to reduce infiltration of harmful particulates, and chemicals as well as extreme temperatures, animals and insects, wind and the like. However, the operation of a business or its facility can sometimes be changed to influence the composition of the interior microbiome and make it more similar to an exterior microbiome without an intolerable loss of the desired protective features of a structure. The improved microbiome can result in health benefits of workers of the business and other business efficiencies, such as reduced spoilage of products.

### II. Types of Business Facilities

(a) Health Care Facilities

Health care facilities include hospitals, surgery centers, dialysis centers and the like. Facility performance indicators typically include at least one of type, severity and frequency of human or animal infections experienced, detected, and/or measured within the facility. Examples of microbes and infection types that cause reductions in performance include ventilator-associated pneumonia, Staphylococcus aureus (including methicillin resistant strains), Candida albicans, Pseudomonas aeruginosa, Acinetobacter baumannii, Stenotrophomonas maltophilia, E. coli 0157:H7, Clostridium difficile, Tuberculosis, Urinary tract infections, pneumonia, Gastroenteritis, Enterococcus (including Vancomycin-resistant strains), Legionnaires' disease and Puerperal fever.

(b) Factory Facilities

Factory facilities include food processing and manufacturing plants in which raw or partially processed food is converted into a further processed food or a finished food ready for packaging. Examples of factory facilities include plants or business where one or more of the following processes take place: yogurt production, poultry processing, ground beef production, vegetable processing (lettuce/ready-to-eat salads, carrots, tomatoes), and nuts/peanut butter production. Microbial contamination within a factory facility generally leads to a reduction in performance, which causes loss of product, and increased wastage. Examples of performance reducing microbial contamination, and related illnesses, include E. coli, including 0157:H7, botulism, bovine spongiform encephalopathy, Listeria, Campylobacter, norovirus, Trichinosis, Staphylococcus aureus, and Salmonella.

Livestock rendering plants are food processing factory facilities where animals, such as pigs and cows, are slaughtered, cleaned, and/or cut into usable portions for either sale directly to consumers or use by an additional processing facility to make finished products such as sausage, ground beef, and the like. These types of factory facilities are also susceptible to microbial contaminations and reductions in performance, as described herein.

Breweries and wineries are beverage processing factory facilities that perform controlled microbial fermentation to manufacture beer, wine, distilled spirits, and/or herbal or tea-based drinks such as kombucha. These types of factory facilities are also susceptible to microbial contaminations and reductions in performance. For example, in some instances microbial contaminations result in the production of product that fails to meet desired or required specifications. These batches are thus unusable and result in lost profits. Examples of performance reducing microbes include those identified above, as well as naturally occurring microbes present within the produced food or beverage.

Other food processing factory facilities include dairy and non-dairy farms. Dairy farms generally include farms where milk is collected from milk-producing animals, such as cows, goats, and sheep. Non-dairy farms generally include barns where livestock is kept in cages and shelters, such as chicken houses. These types of factory facilities are replete with many different types of microbes that must be monitored and controlled to prevent microbial contamination leading to performance reduction.

Non-dairy farms also include fish farms, such as freshwater and saltwater facilities that cultivate various varieties of fish (such as salmon, trout and tilapia) and shellfish (such as clams, oysters, mussels, shrimp, lobster, and crabs). Many fish farms have water conditioning devices which utilize a fixed bed substrate that harbors microbes that facilitate health of the fish. This fixed bed substrate commonly harbors such desirable microbes. Performance improvement may occur as water for the tanks and pools is run through the water conditioning device, thereby exposing the tanks and pools to microbes that have proliferated in the device.

Factory facilities also include facilities or plants manufacturing pharmaceuticals. These types of facilities include those that manufacture drugs intended to treat or cure disease such as monoclonal antibodies and other recombinant proteins, as well as those that produce over-the-counter medications, such as aspirin and acetaminophen. Pharmaceutical manufacturing facilities may be either biological-based (CHO, E. coli) or synthetic chemistry-based. In either case, these types of facilities are susceptible to performance reducing microbial contamination, as discussed herein.

Medical device manufacturing factory facilities are facilities or plants in which devices are manufactured for the purpose of treating and/or curing a medical condition. Some medical device manufacturing facilities provide invasive medical devices, such as syringes, catheters, artificial joints, and pacemakers. These types of factory facilities and medical devices require utmost attention in preventing microbial contamination, and therefore will benefit from practices of the present invention.

(c) Vehicles

Business facilities also include commercial vehicles, such as ships, business, trains, trucks and airplanes. One example of a vehicle is a cruise liner. Cruise liners are ships used primarily for recreation, particularly those which house more than 100 people for multiday trips. Other examples of vehicles include submarines and commercial aircraft. The close and contained environment within these types of vehicles commonly leads to microbial contamination and thus performance reduction. Examples of performance reduction for these vehicles includes various illnesses caused by bacteria and viruses, particularly norovirus, suffered by passengers and/or crew.

(d) Housing

Business facilities also include commercial housing such as prisons, retirement homes, hotels, hospitals, doctor offices, medical centers, athletic facilities and gyms, public pools, public bathrooms, schools, and dormitories.

(e) Consumer Food Facilities

Business facilities also include any type of consumer food facility, including restaurants and retail grocery stores. Such facilities include restaurants that are part of a chain (2 or more locations) having standardized facilities and equipment between locations.

(f) Offices

Business facilities also include office complexes, such as those of lawyers, accountants, architects, engineers and other service providers. Such office complexes often have individual offices, communal areas, bathrooms, rooms where food is stored or consumed. Such facilities often have an HVAC system operating by recycling indoor air, and lack operable windows. Recirculation ventilation systems are typically known as Variable Air Volume systems and typically introduce little to no outside air to the interior of the facility.

(g) Research Facilities

Research facilities typically include laboratories and office space. They typically have all the components of ordinary offices but in addition can provide additional sources of toxic chemicals, radiation and microorganisms.

### III. Determining a Microbiome

A microbiome is determined from samples obtained from one or more representative locations of a space to be characterized by the microbiome. The space can be an interior or exterior space. The samples can be taken from air, dust, surfaces, and water. Changes in a microbiome are preferably monitored over time. An interior microbiome can be determined before and after each change in the operation of the facility or the business to determine whether the change has a corresponding change in the interior microbiome. The exterior microbiome can likewise be determined before and after changes in the facility. Alternatively, however, a reference exterior microbiome can be used instead of the actual exterior microbiome for purposes of comparison with the interior microbiome. A reference exterior microbiome is a microbiome that has been previously determined and associated with beneficial, neutral or harmful consequences to health. Interior and exterior microbiomes can be determined with any desired frequency, which can be hourly, daily, monthly, yearly, or any combination thereof depending on the facility and the intended purpose of the monitoring. Thus, the sampling period can range from less than one hour to greater than one year. Sampling can be automated at recurring or programmed intervals or can be responsive to a specific event, such as a change in a facility or business operation.

Samples can be obtained by any technique not materially altering or destroying the nucleic acids contained therein. A surface can be sampled by swabbing with a sterile cotton or nylon swab. Material picked up from the surface is then typically rinsed from the swab with sterile solution. For air and other gases, sampling can be done, for example and, using a vacuum pump to pull the air or other gas through a filter to which microbes adhere or become otherwise entrapped. Water/liquid samples can also be obtained from sources such as drains, taps and sinks.

The characterization of samples typically involves identification of nucleic acids in the sample. The sample can be subjected to a process to extract nucleic acid, which can be DNA or RNA. Sequence analysis can be performed by determining the nucleotide sequence of all nucleic acid in the sample or by some portion thereof. Sequence analysis can be performed by hybridization to a probe or an array of probes. Sequence analysis can also be performed by nucleic acid sequencing. Sequencing of RNA can be used as an indicator of viability of the cells to determine which cells in the sample were living or dead at the time of sampling. Nucleic acids can also be characterized sufficient to type associated microbes by hybridization assay or selective amplification, such as by RFLP analysis, PCR analysis, STR analysis, Illumina sequencing and AmpFLP analysis, and the like.

Although any form of sequencing can be used, so called next generation or massively parallel methods offer considerable advantages over traditional Sanger and Maxam Gilbert sequencing. Some next generation sequence methods amplify by emulsion PCR. A target nucleic acid immobilized to beads via a target capture oligomer provides a suitable starting material for emulsion PCR. The beads are mixed with PCR reagents and emulsion oil to create individual micro reactors containing single beads (Margulies et al., Nature 437, 376-80 (2005)). The emulsion is then broken and the individual beads with amplified DNA are sequenced. The sequencing can be pyrosequencing performed for example using a Roche 454 GS FLX sequencer (454 Life Sciences, Branford, Conn. 06405). Alternatively, sequencing can be ligation/detection performed for example using an ABI SOLiD Sequencing System (Life Technologies, Carlsbad, Calif. 92008). In another variation, target nucleic acids are eluted from the target capture oligomer and immobilized in different locations on an array (e.g., the HiScanSQ (Illumina, San Diego, Calif. 92121)). The target nucleic acids are amplified by bridge amplification and sequenced by template directed incorporation of labeled nucleotides, in an array format (Illumina). In another approach, target nucleic acids are eluted from the target capture oligomer and single molecules are analyzed by detecting in real-time the incorporation nucleotides by a polymerase (single molecule real time sequencing or SMRT sequencing). The nucleotides can be labeled nucleotides that release a signal when incorporated (e.g., Pacific Biosciences, Eid et al., Sciences 323 pp. 133-138 (2009) or unlabeled nucleotides, wherein the system measures a chemical change on incorporation (e.g., Ion Torrent Personal Genome Machine (Guilform, Conn. 94080)).

High-throughput screening technologies and methods can be used to analyze the microbiome of at least one of a facility, a vehicle, housing, a consumer food facility, or equipment. High-throughput screening methods generally use robotics, data processing and control software, liquid handling devices, and sensitive detectors to rapidly conduct high numbers of chemical, genetic, or pharmacological tests. High-throughput technologies and methods are capable of screening approximately 10 million samples per hour.

The sequence analysis can be targeted to specific DNA or RNA sequences, such as those associated with rRNA, such as 23S rRNA or 16S rRNA, which can be used to identify which species/genus/taxa of microbes are present and the relative abundance of each; those associated with antibiotic resistance genes (see Liu et al., Nucleic Acids Res. 2009 Jan;37(Database issue): D443-7); or those associated with indicator genes, which are associated with improved performance of the system or reduced performance of the systems and which may or may not have a known function. Antibiotic resistance genes, genes encoding enzymes that break down or produce molecules such as volatile organic compounds (VOCs), or other indicator genes can be sequenced, either as part of a metagenomic sequencing or as amplified products to provide a measurement of the total amount of a particular biological, biochemical or pharmacological function present inside the structure. The sequence identification step can determine whether any nucleic acid sequences associated with an indicator taxa is present. An indicator taxa is an organism that is associated with a positive or negative impact of a performance indicator. For example, MRSA is a bacterial indicator taxa for many facilities, as are other pathogenic organisms. An overabundance or underabundance of an indicator taxa, or genes associated with an indicator taxa, within a microbiome can be used to determine current and/or future under, or over-performance of the system. An indicator taxa can also be an operational taxonomic unit (OTU) or a subset of an OTU.

The sequence analysis can be a metagenomic approach, which sequences all DNA captured by the sampling methods. Metagenomic sequencing provides a much richer data set than amplifying markers such as 16S rRNA and allows for greater insight into the microbiome of the facility. Because microbes evolve far faster than multicellular organisms, they are constantly adapting to new environmental conditions and can undergo natural selection to allow a much higher degree or proliferation and colonization of a facility over time, such as adapting to more effectively colonize a particular surface. Genetic changes that allow such adaptation are captured by metagenomic sequencing but not by amplifying and sequencing only a specific marker region.

Antibiotic resistance may take the form of a spontaneous or induced genetic mutation, or the acquisition of resistance genes from other bacterial species by horizontal gene transfer via conjugation, transduction, or transformation. Many antibiotic resistance genes reside on transmissible plasmids, facilitating their transfer. Exposure to an antibiotic naturally selects for the survival of the organism with the genes for resistance. In this way, a gene for antibiotic resistance may readily spread through a microbiome.

Some antibiotic resistant indicator taxa have acquired resistance to first-line antibiotics, thereby necessitating the use of second-line agents. Multidrug resistant indicator taxa have acquired resistance to second- and even third-line antibiotics. For these types of indicator taxa or OTUs, timely detection and monitoring of the microbiome may be important to prevent performance reduction.

Examples of antibiotic resistant indicator taxa include Staphylococcus aureus, methicillin-resistant Staphylococcus aureus, Pseudomonas aeruginosa, Klebsiella pneumonia, Mycobacterium tuberculosis, Neisseria gonorrhoeae, vancomycin-intermediate S. aureus, vancomycin-resistant S. aureus, extended spectrum beta-lactamase, vancomycin-resistant Enterococcus, fluoroquinolone-resistant Salmonella, fluoroquinolone-resistant E. coli, clindamycin-resistant C. difficile, and multidrug-resistant A. baumannii. Microbiome analysis can determine the amount of antibiotic resistance capability present in a facility as well as when the amount of resistant organisms if growing or shrinking over time and as a function of changing facility operation parameters.

In some methods, all of the DNA (or all of the nucleic acid or all of the RNA) from a sample is sequenced. This may be done with or without an amplification step. This provides information about not only which species/genus/taxa of microbe is present and its relative abundance, but also which known pathogenic genes, antibiotic resistance, and indicator genes are present in the sample.

A wide variety of non-microbiome data can be collected in combination the facility microbiomes. Examples include type of ventilation, air flow, exposed surface composition (carpet, ceiling tiles, paint, upholstery, and fabric of staff clothing), lighting (natural and artificial), temperature, relative humidity, frequency of cleaning, chemicals used for cleaning, surface moisture pH, presence and amount of volatile organic compounds, formaldehyde, CO2 level, O2 level, CO level, NO2 level, VOC level, waste container location and frequency of removal, amount of airborne particulates and particle size distribution, lighting, facility volume, heating and cooling systems, and occupant density. These data can be used to determine which changes to make to facility or business operation to influence the interior microbiome.

VOCs are chemicals with low molecular weights, high vapor pressure and low water solubility. These chemical characteristics allow VOCs to easily evaporate into the air or “off-gas”. VOC's can be produced through industrial or biological processes. In the industrial setting, VOC's are commonly used or are created as by-products in the manufacture of paints, pharmaceuticals, refrigerants, petroleum fuels, household cleaners, and other products. VOC's can also be produced by microorganisms such as fungi and bacteria. During metabolism, microbes can produce these chemicals, specifically called Microbial Volatile Organic Compounds (MVOC's). MVOCs are composed of low molecular weight alcohols, aldehydes, amines, ketones, terpenes, aromatic and chlorinated hydrocarbons, and sulfur-based compounds, all of which are variations of carbon-based molecules. MVOC's are typically associated with mold and bacterial growth. MVOC's are products of the microbes' primary and secondary metabolism. In primary metabolism, the organism breaks down food in the environment to extract nutrients needed for the maintenance of cell structures and, in the process, creates MVOCs as by-products. In secondary metabolism, the production of MVOCs is driven by the competition for resources in a nutrient-poor environment. MVOCs produced during primary fungal metabolism include ethanol, 1-octen-3-ol, 2-octen-1-ol, and benzyl cyanide. Some fungi can produce ethanol by fermentation. Others, such as Aspergillus niger, Aspergillus flavus, and Penicillium roqueforti are able to produce 1-octen-3-ol. Low concentrations of this particular MVOC emit a mushroom-like or musty odor. Aspergillus flavus can also produce 2-octen-1-ol which has been described as “a strong musty, oily odor”. The fungus Botrytis cinerea can produce benzyl cyanide which emits a grassy odor. MVOCs produced during fungal secondary metabolism include 2-methyl-isoborneol, geosmin (1-10-dimethyl-trans-9-decalol), and terpenes. Chaetomium sp. is known to produce 2-methyl isoborneol and geosmin emitting a musty, earthy odor. Penicillium aurantiogriseum and Penicillium vulpinum growing on oat substrate have been shown to produce terpenes.

### IV. Changing the Operation of a Facility or Business

The interior microbiome can be changed to more closely resemble a desired exterior microbiome by changing the operation of the facility or the business in one or more respects. In general, changes in the facility means changes in the physical nature of the structure and its components or its systems or their operation, whereas changes in the business refer to changes in the business practices, such as interaction so the business with its employees, customers, contractors or suppliers. However, there is not a strict dichotomy between changes in facility and changes in a business and it does not matter whether some changes, such as a cleaning regime, might be considered to fall into either or both categories. If the business facility already had a satisfactory exterior microbiome without any changes, the interior microbiome can be changed to more closely resemble the existing exterior microbiome. However, in other situations, the exterior microbiome is itself unsatisfactory or at least less than optimal and is also changed. The changes to the exterior and interior microbiomes can be the same or different. For example, planting exterior trees can change the exterior microbiome and with it, optionally in conjunction with other changes discussed below, the interior microbiome. But other changes, such as introducing operable windows into a structure, entirely or at least primarily affect the interior of the structure.

The change to the operation of the facility or business can be known from prior experience to associate with a beneficial change in the exterior or interior microbiome or can be empirical with the effect to be determined by monitoring of the microbiome and its downstream effects on one or more operational parameters.

Changes affecting the exterior of a structure include introducing plants populating the exterior. For example, lawns, flowers, herbs, vegetables, fruits, bushes, hedges and trees can be planted. Ponds, streams or fountains can also be introduced Animals can also be encouraged to be brought into the exterior by removing legal or quasi legal restrictions and optionally providing supporting measures, such as a source of drinking water, grass or other plants for food and waste disposal receptacles. The animals can be farm animals or companion animals. Sheep, goats or chickens are a preferred farm animal and dogs a preferred companion animal. In some instances, when a facility is proximate to a source of undesired substances, such as pollution or chemicals, diffusion of the substances to the exterior of the premises can be reduced by erecting a wall or planting trees at the around the exterior forming a physical barrier. One measure of whether an exterior microbiome has favorably changed is the number of microbial species present at over a detectable background or other set threshold level in the exterior. For example, an exterior microbiome can be considered to have been significantly improved if a least 5, 10, 25, 50, 100, 200 or 500 new microbial species occur at a detectable level within 100 m of any outerwall of facility structure(s). Preferably such new specifies are associated with neutral or beneficial characteristics for human health and/or are preferentially associated with exterior rather than interior microbiomes.

Similar changes regarding introduction of plants, animals and open water, can also be made to the interior. Plants should be compatible in size and growth requirements with an indoor environment. Animals are typically companion animals such as dogs and cats. Water can be in the form of fountains, ponds, fish tanks and the like.

Some changes to the interior stem from changing the HVAC system. Such a system has a number of subsidiary operation parameters, such as airflow rate, filtration, and facility filter pore size (as well as the frequency of changing filters), temperature and temperature fluctuations of the air, and the relative humidity of the air. Mechanical ventilation and natural ventilation can both be used in a facility. Displacement ventilation can also be used. One measure of the operation of an HVAC system is the number of air changes per hour (total volume of the facility that is changed over by the ventilation system per unit time).

One change that can be made to the HVAC is to increase air intake from the exterior and thereby facilitate transfer of the exterior microbiome to the interior. The air intake from the exterior can be increased such that it falls within a preset range, for example 10-100%, or 20-100% or 50-100% or 75-100% or 25-75% of total air delivered by the HVAC system is exterior air. Such a change can be made with or without other changes such as increasing number of air changes per hour and reducing or increasing filtration. Increasing intake from the exterior serves to introduce exterior microbes to the interior. As well as the direct introduction of microbes from the exterior, competition between these microbes and microbes already in the interior can cause additional changes in the interior microbiome. Competition can affect both airborne microbes and those on surfaces. Such changes to the HVAC can be made with or without changes to the exterior, such as those discussed above. If changes are made to the exterior, changing the HVAC to increase air take from the exterior is beneficial in allowing the benefits of the exterior microbiome to be transferred to the interior.

Although obtaining increased ventilation from the exterior is beneficial in changing the interior microbiome to more closely resemble that of the exterior, increasing ventilation from the exterior can also result in undesired transfer of particulates or chemicals from the exterior to the interior, or can overwhelm the capacity of the heating or cooling system if the external temperature differs substantially from the desired interior temperature. Accordingly, changing the HVAC system to increase air intake from the exterior can be performed responsive to monitoring of the exterior environment for particulates, chemicals, temperature, humidity among other variability. When the monitoring indicates that the exterior environment has particulates or harmful chemicals below acceptable threshold levels, or the monitoring indicates a temperature or humidity which will not overwhelm the heating or cooling capacity of the HVAC system, the HVAC system is switched to take increased air from the exterior. The system can be switch back to reduced air intake from the exterior, when the monitoring indicates that the level of particulates, harmful chemicals, temperature, humidity and so forth has returned to levels above threshold or beyond the capacity of HVAC system.

The HVAC system can also be changed to change the temperature or humidity within the structure. Such changes can both stimulate or inhibit growth of certain microbes and affect microbes both in the air and on surfaces. Optionally, the temperature and humidity can be made to vary simulating an outside environment, although without extremes of temperature sufficient to cause discomfort of the workers. Permitting variations in temperature and humidity increases the periods for which air intake can be increased from the exterior. Sustained indoor temperatures are usually set within a range of about 20-24 C and relative humidities within a range of 30-70%. However, broader ranges can be acceptable particularly if higher temperatures are combined with lower humidities and vice versa and if the temperature and relative humidity are cycled so upper and lower levels are obtained only at parts of the day. The interior temperature can be permitted to vary within a preset range, such as from 14-28° C. or 16-27° , or 18-26° C. Likewise, the humidity can vary within a preset range, such as from 15-85% or 25-75% or 30-70%. Alternatively or additionally, the temperature can be varied such that for part of the days, the temperature is at a range lower or higher and preferably both than usual for sustained indoor temperatures, for example, a temperature in the range of 15-19° C. at the low end and/or a temperature of 25-27° C. at the high end. Likewise the relative humidity can be varied to include a relative humidity of about 20-29% at the low end and/or 71-90% at the high end. Preferably, temperature and relative humidity are cycled so the low end of the temperature range occurs at the high end of the relative humidity range. Optionally, the cycling can include colder periods of higher humidity at the start and end of the day, and a period of higher temperature and lower humidity in the middle of the day or vice versa. Alternatively, the cycling can include a colder period of higher humidity at the beginning of the day and a hotter period of lower humidity at the end of the day or vice versa. Many other cycles are possible that vary temperature and humidity more than usual in an indoor environment without excessive or any discomfort to human occupants.

The HVAC system can also be changed to increase or decrease the stringency of filtration, if any. Such changes can affect the number and size of microorganisms and particulates brought into the structure.

As well as or instead of changing mechanical ventilation systems, the structure of the facility can be changed to introduce operable windows. These can be opened by workers as external temperature and other conditions permit. The windows can also be coupled to a monitoring system as described for the HVAC so as to permit their opening only when exterior conditions are overall likely to confer benefits when transferred to the interior. Other changes include the square footage of windows, the number of panes and the type of transparent material.

Another example of a facility operation that can be changed is the cleaning regime of a facility. Such a system encompasses a number of subsidiary operation parameters, such as the chemicals used, the surfaces cleaned, the method of cleaning, and the frequency of cleaning. Sterilization procedures (for hospitals in particular, which often use UV light and/or chemicals to clean) also represent key operation parameters. In general, a more rigorous cleaning regime and in particular the use of sterilizing solvents or radiation reduces the diversity of the microbial population and can select for microbes most resistant to the solvents or radiation. As with therapeutic use of antibiotics, such a regime can be useful for short term treatment of threatening pathogens, but does not provide an acceptable long term environment. The nature, frequency, and type of cleaning protocols and their frequency are key changeable facility operation parameters. In particular the combination of location, frequency and identity of cleaning chemicals/reagents used is a key changeable facility operation parameter. Frequency and duration of sterilization using a device such as portable room disinfection systems that use pulsed xenon ultraviolet light to destroy viruses, bacteria, mold, fungus and bacterial spores in the patient environment that cause healthcare associated infections is a changeable facility operation parameter (see U.S. Ser. Nos. 13/706926 and 13/156131).

Another type of facility change is to the type of surfaces (e.g. carpet versus hard floor and composition, e.g., fiber, wood, linoleum) present in a facility. All surfaces (ceiling, floors, walls, doors, and doorknobs and handles, equipment surfaces, ceiling tiles, paint, furniture composition, fabric, carpet, computers, light switches, personal electronic devices, bed linens, baseboards, wainscoting, materials inside wall cavities, hand drying devices and the like) in a facility, their location(s) and their relative abundance can be changed. Changes include increasing the ratio of natural to synthetic materials on surfaces.

Further changes can be made in lighting, both in placement of lights and types (incandescent, LED, fluorescent, natural lighting).

Further changes that can be made include changes to the plumbing. The plumbing includes the nature and location of pipes and faucets and the like that deliver and remove fluids from the structure.

A further change is to increase a concentrated source of microbes into the interior of a structure. Such microbes can be Proteobacteria or Acinetobacter, among others.

Other changes are in the operation of business including the number of workers per square foot in the structure, the hours of operation of the business, the zones within the structure used for particular functions, such as bathrooms, kitchens, and storage of products. Other changes includes the turnover and flow of human occupants. Other changes include changes to the contractors, suppliers or customers of the business. Devices and surfaces can be introduced to reduce transmission or dissemination of microbes, such as contamination control mats.

Microbes in the interior of a structure that can be increased or decreased in response to changes to the design and operation of the structure can include Streptococcus, Corynebacterium, Flavimonas, Lactobacillus, Burkholderia, Bacillus, Bradyrhizobium, Propionibacterium, Enterobacter, Neisseria, Pseudomonas, Streptococcus, Staphylococcus, Nictrospumilus, Nitrosospira , Nitrosomonas, Kytococcus sedentarius, Staphylococcus epidermidis, S. haemolyticus, Ralstonia pickettii, Enterobacter, Kocuria rhizophila, Micrococcus luteus, Microcystis aeruginosa, Prochlorococcus marinus, Methylocella silvestris, Methylobacterium extorquens, Pseudomonas, Staphylococcus epidermidis, Enterococcus faecalis, Klebsiella , Propionibacterium, Corynebacterium, Micrococcaceae, Bacteriodaceae, Methylobacterium, Sphingomonas, Mycobacterium, Pseudomonas aeruginosa, Legionella, Mycobacterium, Sphingomonas, Propionibacterineae, Xanthomonadaceae, Micrococcineae, Sphingomonas, Caenibacterium, Enterobacteriaceae and Corynebacterineae.

### V. Assessing the Effects of Changed Facility or Business Operations

After implementing change(s) to the interior and/or exterior space of a facility, the effect of the change is assessed by redetermining microbiomes from the interior and optionally, the exterior. The redetermined microbiome after change(s) may differ from that before in the types and absolute or relative proportions of microbes represented. The interior microbiomes before and after the change(s) are compared with an exterior microbiome to see which more closely resembles it. The exterior microbiome for this comparison can be the actual exterior microbiome of the facility before or more usually after the change(s). Alternatively, the exterior microbiome can be a reference microbiome representing an actual exterior microbiome from elsewhere known to be associated with beneficial healthful effects or a composite of such exterior microbiomes. If the interior microbiome after the change(s) more closely resembles the exterior microbiome than the interior microbiome before the change(s), then the change(s) can be retained in subsequent operation of the business. If the interior microbiome after the change(s) does not more closely resemble the exterior microbiome than the interior microbiome before the change(s), then additional change(s) can be made and the interior and optionally exterior microbiomes redetermined. The process can be repeated iteratively until change(s) are identified that result in the interior microbiome more closely resembling an actual or reference exterior microbiome. If the improved interior microbiome is the result of multiple changes, further iterations can be performed to dissect the effect of individual changes, and only those effective to change the interior microbiome to more closely resemble and exterior microbiome are retained in subsequent operation of the business. The performance of the business can also be correlated with the changes in microbiome, such as the reduction of patient infections in a hospital, increased worker performance, and reduced employee absenteeism and sickness corresponding to the interior microbiome more closely resembling the exterior microbiome.

Once the facility or business has been changed to improve the interior microbiome and consequently one or more facility operating parameters, the interior will not necessarily remain in its then current state indefinitely. Microbes sometimes adopt to the changed environment and the microbiome can therefore drift away from a desired state with time. Accordingly, further monitoring of the interior microbiome can be performed even after a desired state has been achieved and the process of changing the facility or business repeated should the interior microbiome drift significantly away from the exterior microbiome used as a comparator.

Resemblance between interior and exterior microbiomes can be assessed by various criterion. One measure of similarity is of the total number of microbes at a level exceeding a threshold. The threshold can be defined as a limit of detection or otherwise. For example, an interior microbiome having 10 microbial species above a threshold shows more resemblance to an exterior microbiome having 20 microbial species above a threshold than does an interior microbiome having 5 microbial species above a threshold. Another measure is the number of common microbes in the top 3, 5, 10 or 50 represented species. For example, an interior microbiome having 5 common microbial species of the top ten most represented species with an exterior microbiome has more resemblance to the exterior microbiome than an interior microbiome having 3 such common microbial species. More sophisticated analysis of quantifying similarity between microbiomes can be performed by pattern matching algorithms such as that based on principal component analysis, Euclidean Distance metric, Euclidean Squared, Pearson Correlation, Pearson Squared, Spearman Confidence or Correlation, and other like techniques can be used. Each profile being compared may be seen as a pattern setting an explicit series or matrix of points such as across microbes, proportions and space, and the comparison looks for data that reflects this defined series of points or matrix.

Particularly as data on interior and exterior microbiomes associate with a healthy environment accumulate, changes in interior microbiome can be compared directly with desired or undesired features of an interior microbiome. Known desired features include overall diversity of microbes, including bacteria, viruses and fungi. The change can be in airborne, fomite or dust microbes or any combination thereof. Other known desired features includes presence Proteobacteria or Acinetobacter. Undesired features include bacteria associated with pathogenicity, allergy, toxicity or drug resistances, such as Mycobacteria, Aspergillus, Chlostridium, Influenzae, Penumococcus or Staphylococcus. If the interior microbiome after the change shows an increase in a desired feature of decrease in an undesired change after a change in facility or business operations, then the change can be retained in subsequent operation of the business. Such direct comparisons can be performed as well as or instead of comparison with an exterior microbiome.

### VI. Consequences of Changing an Interior Microbiome

Changing the operation of the facility or business to make the interior microbiome more closely resemble an exterior microbiome or otherwise adapt favorable characteristics of an exterior microbiome can have a number of advantages in subsequent operation of the business.

The frequency, severity and type of infections, sickness, and/or mortality of the occupants (human and/or animal), as well as the outcome of any treatment of infection or sickness, are key facility performance indicators. Employee sick days/absenteeism is another performance indicator that can be related to sickness as a result of a facility microbiome. Hospital-acquired infection is a performance indicator of hospital. Any or all of these parameters can be reduced.

The rate of spoilage and shelf life of food products in a facility are key facility performance indicators for food processing and storage facilities. The rate of spoilage can be reduced and shelf life increased.

The bioburden in food products, i.e., the colony forming units per gram of product, is a key facility performance indicators for food processing and storage facilities. The presence and amount of any known pathogen(s) or indicator taxa/OTUs in a food product is also a key facility performance indicator for these types of facilities. The bioburden of all microbes or known pathogens or indicators of taxa/OTUs can be reduced.

The yield, efficiency, and cost of any production method are key facility performance indicators. Examples include how often machinery or the facility needs to be shut down for cleaning, and how many days per week/month/year of operation are lost to microbiome-related issues. Another example is whether a cruise ship has to terminate a cruise early due to contamination/illness. Any of these parameters can be improved.

The frequency and type of reportable incidents relating to the microbiome of a facility are key facility performance indicators. For example, the requirement and frequency at which government or other authorities need to be notified of reportable incidents (FDA notification for food borne illness, food recall, CDC and state and local authorities for hospital acquired infection, identification of pathogens in incoming water supply) are key performance indicators for pharmaceutical and medical device manufacturers as well as medical facilities of all types. The frequency and severity of such incidents can be reduced.

The amount or concentration of ozone, VOCs, MVOCs, particulates, NO₂ and any combination thereof are also performance indicators that can be reduced.

### VII. Data Collection and Correlation

Improvements in facility performance indicators can be correlated with preceding changes in facility or business operation and consequent changes in exterior or interior microbiome and the results stored in a database. This database can then be used in predicting the effect of changing facility or business operations on interior or exterior microbiomes and facility performance indicators in other business facilities.

### VIII. Computer Implementation

Many of the steps involved the disclosed methods can be implemented on a suitably-programmed computer. Such steps include particularly storing and comparing microbiomes. Computers can also store databases as described above. The computer can also be programmed to provide recommended changes to the operation of the facility or business and to predict the effect of such changes on operating parameters. The computer can also be programmed to operate monitoring equipment used to monitor a microbiome and to receive data from such equipment characterized the microbiome. The computer can also be programmed to operate facility equipment such as HVAC systems, for example by modifying the ratio of interior to exterior air that is circulated throughout the structure.

A computer system can include a bus which interconnects major subsystems such as a central processor, a system memory, an input/output controller, an external device such as a printer via a parallel port, a display screen via a display adapter, a serial port, a keyboard a fixed disk drive, and an internet connection. Many other devices can be connected such as a scanner via I/O controller, a mouse connected to serial port or a network interface . Many other devices or subsystems may be connected in a similar manner. Also, it is not necessary for all of the devices to be present to practice the present invention, as discussed below. The devices and subsystems may be interconnected in different ways. Source code to implement the present invention may be operably disposed in system memory or stored on storage media such as a fixed disk, compact disk or the like. The computer system can be a mainframe, PC, table or cell phone among other possibilities.

Although the invention has been described in detail for purposes of clarity of understanding, certain modifications may be practiced within the scope of the appended claims. All publications including accession numbers, websites and the like, and patent documents cited in this application are hereby incorporated by reference in their entirety for all purposes to the same extent as if each were so individually denoted. To the extent difference version of a sequence, website or other reference may be present at different times, the version associated with the reference at the effective filing date is meant. The effective filing date means the earliest priority date at which the accession number at issue is disclosed. Unless otherwise apparent from the context any element, embodiment, step, feature or aspect of the invention can be performed in combination with any other.

1-50. (canceled)

51. A method of improving a business environment, comprising:
a. changing the operation of a facility by changing the density of human occupants per square foot of the interior;
b. determining the microbiome of the facility in response to the change in human occupant density or at automated recurring or programmed intervals, and thereby detecting one or more pathogenic viruses; and
c. after detecting the one or more pathogenic viruses, changing one or more parameters of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.

52. The method of claim 51, wherein the microbiome of the facility is determined in response to the change in human occupant density.

53. The method of claim 51, wherein the microbiome of the facility is determined at automated recurring or programmed intervals.

54. The method of claim 51, wherein the determining detects RNA from pathogenic RNA viruses.

55. The method of claim 51, wherein the determining comprises polymerase chain reaction (PCR).

56. The method of claim 51, wherein the air intake from the exterior of the facility is increased to 10-100%, 20-100%, 50-100%, 75-100% or 25-75% of air delivered by the HVAC being exterior air.

57. The method of claim 51, wherein the air intake from the exterior of the facility is increased only when particulates in the exterior air are below a threshold.

58. The method of claim 51, wherein the air intake from the exterior of the facility is increased, and the interior temperature is allowed to vary within a set range without reducing the amount of exterior air.

59. The method of claim 58, wherein the temperature is allowed to vary between 14-28° C., 16-27° , or 18-26° C.

60. The method of claim 51, wherein the air intake from the exterior of the facility is increased, and the relative humidity inside the structure is allowed to vary within a set range without reducing the amount of exterior air.

61. The method of claim 51, wherein determining the microbiome responsive to the density of human occupants per square foot occurs hourly.

62. The method of claim 51, wherein the sampling period for determining the microbiome responsive to the density of human occupants per square foot is less than one hour.

63. The method of claim 51, wherein a computer determines the microbiome of the facility and operates one or more parameters of the ventilation system.

64. The method of claim 51, additionally comprising monitoring exterior air, wherein the air intake from the exterior is increased when particulates in the exterior air are below a threshold.

65. The method of claim 51, wherein the change reduces the interior microbiome content of gene sequences associated with pathogenicity.

66. A method of improving a business environment, comprising:
a. determining the microbiome of a facility responsive to the CO₂ level in the facility, and thereby detecting one or more pathogenic viruses; and
b. after detecting the one or more pathogenic viruses, changing one or more parameters of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.

67. A method of improving the environment in a facility, comprising:
a. determining a microbiome of an interior space of the facility by detecting microbes or gene sequences associated with pathogenicity;
b. changing the operation of the facility by changing the density of human occupants per square foot of the interior;
c. redetermining the microbiome of the interior space by detecting microbes or gene sequences associated with pathogenicity in response to the change in human occupant density;
d. comparing the interior microbiome before and after the change, wherein an increased representation of microbes or gene sequences associated with pathogenicity is detected after the change; and
e. making one or more additional changes to the operation of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.

68. The method of claim 67, wherein the determining and redetermining detect RNA from pathogenic RNA viruses.

69. A method of improving the environment in a facility, comprising:
a. determining a microbiome of an interior space of the facility by detecting microbes or gene sequences associated with pathogenicity;
b. detecting a change in the CO₂ level in the facility;
c. redetermining the microbiome of the interior space by detecting microbes or gene sequences associated with pathogenicity in response to the change in the CO₂ level in the facility;
d. comparing the interior microbiome before and after the change, wherein an increased representation of microbes or gene sequences associated with pathogenicity is detected after the change; and
e. making one or more additional changes to the operation of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.

70. The method of claim 69, wherein the determining and redetermining detect RNA from pathogenic RNA viruses.

71. The method of claim 69, wherein the microbiome of the facility is determined in response to the change in human occupant density.

72. The method of claim 69, wherein the microbiome of the facility is determined at automated recurring or programmed intervals.

73. A system for improving the environment in a facility, comprising:
a. a sampling device or material for obtaining a sample;
b. a sample analyzer for determining a microbiome of an interior space of the facility by detecting microbes or gene sequences associated with pathogenicity;
c. a device or system coupled to the sample analyzer, wherein the device or system is capable of making one or more changes to the operation of a ventilation system in the facility selected from the group consisting of changing the airflow rate, changing the number of air changes per hour, increasing the air intake from the exterior of the facility, increasing the stringency of air filtration level, reducing pore size of air filtration, and opening operable windows.

74. The system of claim 73, wherein the device or system coupled to the sample analyzer comprises a computer.

75. The system of claim 74, wherein the computer operates the sampling the device and/or the sample analyzer.

76. The system of claim 74, wherein the computer receives data from the sample analyzer.

77. The system of claim 74, wherein the computer stores microbiome databases.

78. The system of claim 74, wherein the computer operates facility equipment to make said one or more changes to the operation of a ventilation system in the facility.

79. The system of claim 73, wherein the sampling device is capable of sampling at recurring or programmed intervals.

80. The system of claim 73, where the sampling device is responsive to a specific event.

81. The system of claim 80, wherein the specific event is a change in a facility operation.

82. The system of claim 73, wherein the system is capable of performing a method comprising:
a. changing the operation of a facility by changing the density of human occupants per square foot of the interior;
b. determining the microbiome of the facility in response to the change in human occupant density or at automated recurring or programmed intervals, and thereby detecting one or more pathogenic viruses; and
c. after detecting the one or more pathogenic viruses, changing one or more parameters of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.

83. The system of claim 73, wherein the system is capable of performing a method comprising:
a. determining a microbiome of an interior space of the facility by detecting microbes or gene sequences associated with pathogenicity;
b. changing the operation of the facility by changing the density of human occupants per square foot of the interior;
c. redetermining the microbiome of the interior space by detecting microbes or gene sequences associated with pathogenicity in response to the change in human occupant density;
d. comparing the interior microbiome before and after the change, wherein an increased representation of microbes or gene sequences associated with pathogenicity is detected after the change; and
e. making one or more additional changes to the operation of a ventilation system in the facility selected from the list consisting of changing the airflow rate, changing the number of air changes per hour, increasing the air intake from the exterior of the facility, increasing the stringency of air filtration level, reducing pore size of air filtration, and opening operable windows.
